(19) United States
(12) Patent Application Publication
(10) Pub. No.: US 2009/0090853 A1
(43) Pub. Date: Apr. 9, 2009

(54) HYBRID MASS SPECTROMETER WITH BRANCHED ION PATH AND SWITCH

(76) Inventors: Alan E. Schoen, Saratoga, CA (US); Jae C. Schwartz, San Jose, CA (US)

Correspondence Address: THERMO FINNIGAN LLC, 355 RIVER OAKS PARKWAY, SAN JOSE, CA, 95134, US

(21) Appl. No.: 11/868,307

(22) Filed: Oct. 5, 2007

(51) Int. Cl. H01J 49/42; H01J 49/34

(52) U.S. Cl. 250/282; 250/292

(57) ABSTRACT

A hybrid mass spectrometer has a branched ion path. A first ion path within the branched ion path operates as a triple quadrupole instrument having a mass selection device, collision cell, and first mass analyzer and provides information on a specific m/z ratio corresponding to ions of interest in a sample. A second ion path within the branched ion path includes a second mass analyzer in the form of an electrostatic trap or other ion trap device. A branched ion transfer device may provide the branched ion path and may include the collision cell. A controller actuates an ion path switch in the branched ion transfer device and diverts from the first ion path to the second ion path in response to a triggering event. Ions at or near the m/z ratio of interest are then analyzed in the trap to obtain more detailed information of a full spectrum.

### FIELD OF THE INVENTION

The present invention relates generally to hybrid mass spectrometers and more specifically to guiding ions to a plurality of mass analyzers in hybrid mass spectrometers.

### BACKGROUND OF THE INVENTION

Triple stage quadrupole mass spectrometers (triple quads) have been in use for many years. These instruments include a quadrupole mass filter Q1 into which ions are guided, a collision cell q downstream from the mass filter Q1, and another quadrupole mass filter Q2 downstream from the collision cell q. A quadrupole mass filter may be operated as a mass filter or as an RF only ion guide. A collision cell may also be operated as an ion guide when collision gas is not present. When both quadrupoles are operated as mass filters, and q is operated as a collision cell, a triple quad may be operated in any of a variety of MS/MS or tandem mass spectrometry modes including precursor ion scan, product ion scan, neutral loss scan, and selected reaction monitoring modes.

Quadrupole mass filters specifically and triple quads in general have several strengths among which are selectability and adjustability of resolution. Ions of one or a range of m/z values may be selected and transmitted from the first quadrupole mass filter Q1 to the collision cell q by suitable adjustment of the amplitude of the RF and DC drive voltages applied to first quadrupole mass filter Q1. Then fragmentation can be caused in the collision cell q, and analysis may be performed in the quadrupole mass filter Q2 to yield greater details about the ions of the m/z or range of m/z values selected for analysis. Also, triple quads are operated by sending an ion beam through the quadrupole devices. Beam instruments operate in space by passing or rejecting or modifying the ion signal as it physically passes through each sequential device. These beam instruments have relatively good resolution and mass accuracy capabilities. However, triple quads have certain limitations including limitations on the number of additional stages of selection and fragmentation that can be performed practically, due to the time required for each step and the less than unity ion transmission of each step. The amount of useful information or specificity increases with each stage, while the amount of useful signal that can be obtained with additional stages of fragmentation and analysis diminishes with each additional stage. Also, since only a single m/z window is transmitted at any given time, in order to obtain information about ions having a broad range of m/z values, such as in a full scan spectrum, additional runs or scans of Q1 and/or Q2 will be required with associated time and duty cycle penalties.

Ion traps have the advantage of being capable of analyzing a whole spectrum in a very short time. They operate by accumulating ion signal in one step and analyze that ion signal rapidly in a subsequent step. MS/MS is accomplished by isolating selected precursor ions in a step subsequent to accumulation, and by fragmenting those ions in a step subsequent to isolation. These steps of isolation and fragmentation can be repeated “n” number of times producing MSⁿ data, another advantage of ion trap mass analyzers. Other ion manipulation operations are also possible. For example, ion traps may be operated in any of a variety of fragmentation modes including collision induced dissociation (CID), electron transfer dissociation (ETD) and pulsed q dissociation (PQD). Many combinations of multiple ion manipulation steps may be concatenated prior to a single analysis step, which consumes the ion population. Each step, however, consumes time, and only the ion accumulation step contributes to sensitivity. The steps other than accumulation contribute to specificity. As a result, since ion signal is not being accumulated during these non-accumulation steps, sensitivity is decreased as the number of these steps increases.

The U.S. Pat. No. 6,177,668 to Hager describes in one of several embodiments a variation on the triple quad in which the third quadrupole, Q2, of the spectrometer can be selectively operated as an ion trap. The spectrometers disclosed in this patent combine some of the advantages of an ion trap with the strengths of a beam type instrument. However, the devices of the Hager spectrometer are operated in both filtering and trapping modes at different times or at different positions in an ion train for generally trapping or triple quad modes of operation.

### SUMMARY

There is a need for a mass spectrometer with full triple quad capabilities while at the same time providing ion trapping capabilities with attendant ion trapping strengths. There is a need for an instrument that enables both triple quad operation and ion trap operation in such a way that ions may be analyzed in the triple quad at the same time that other ions that have been sent to the trap are being stored and/or analyzed. Furthermore there is a need, such as in drug screening applications, in which more than one stage of fragmentation and analysis is available. That is, three or four stages including the traditional triple quad stages or the triple quad stages in combination with the trap would enable improved identification of ions as well as structural details of the compositions of the samples.

It is to be understood that the more general terms “ion beam device” and “beam device” may be substituted for the more specific terms “quadrupole mass filter” and “quadrupole” as they are described below with reference to a mass analyzer downstream of the ion path switch. These ion beam devices may include, but are not limited to, quadrupole filters, ion mobility spectrometry devices, high field asymmetric ion mobility spectrometry (FAIMS) devices, and drift tubes, for example. It is further to be understood that the more general term “non-beam device” may be substituted for the more specific terms “ion trap mass analyzer” and “trap”, as described with reference to a mass analyzer downstream of the ion path switch. Non-ion beam devices may include, but are not limited to, two dimensional traps, three dimensional traps, electrostatic traps, and time-of-flight mass spectrometers, for example. It is also to be understood that beam devices may be operated as non-beam devices such as when a quadrupole is operated as a linear trap. Non-beam devices may be operated as beam devices such as when a trap is operated to eject a stream or beam of ions.

In a simple form, the mass spectrometer of the present invention may include a mass selection device in an ion path, at least one collision cell downstream of the mass selection device in the ion path, and a beam switch that is also downstream of the mass selection device. The beam switch may have at least a first outlet and a second outlet. At least a first mass analyzer including a beam device and a second mass analyzer including non-beam device may be respectively coupled to the first and second outlets. The first and second mass analyzers are to be located downstream of the mass selection device, the at least one collision cell, and the at least one beam switch. As such, the beam switch can direct an ion beam to a selected one of the first and second mass analyzers.

In an embodiment, the mass selection device may include a quadrupole mass filter. The at least one collision cell may be a single collision cell located upstream in the ion path relative to the beam switch. Alternatively, first and second collision cells may be located downstream in the ion path relative to the beam switch. The first and second collision cells may be located upstream of the first and second mass analyzers, respectively.

The mass spectrometer may include first and second ion paths within the more general ion path described above. In one embodiment, the beam switch has an ion gate with a junction and a valve at the junction. In this embodiment, the valve is switchable between a first switching configuration corresponding to guiding ions along the first ion path toward the first outlet and a second switching configuration corresponding to guiding ions along the second ion path toward the second outlet.

The mass spectrometer in accordance with an embodiment of the present invention includes a controller operably connected to the mass selection device and the first mass analyzer. Under user, software, and/or firmware control, the controller initiates a mode of operation including, but not limited to, one or more of a product ion scan mode, precursor ion scan mode, neutral loss scan mode, and selected reaction monitoring (SRM) mode.

The mass spectrometer in accordance with an embodiment of the present invention may include a controller and a detector in which the controller changes the ion path and directs the ion beam into the second mass analyzer in response to detection of a triggering event by the detector. For example, the triggering event may be an occurrence of an m/z peak in the first mass analyzer.

In another simple form, a mass spectrometer in accordance with the present invention may include a mass selection device in an upstream portion of a branched ion path, at least one collision cell in the branched ion path downstream of the mass selection device, and at least one ion path switch in the branched ion path downstream of the mass selection device. In an embodiment of the invention, the ion path switch is configured to alternatively guide ions toward one of first and second branches of the branched ion path. The mass spectrometer may include at least a first mass analyzer including a beam device and a second mass analyzer including a non-beam device. The first and second mass analyzers in this embodiment are to be respectively located in the first and second branches of the branched ion path downstream of the mass selection device, the at least one collision cell, and the at least one ion path switch. The ion path switch is configured to selectively direct ions along the respective branches of the branched ion path to one of the first and second mass analyzers.

In still another simple form, the present invention includes a method of analyzing samples by tandem mass spectrometry. The method may include generating ions from a sample, selecting precursor ions having mass-to-charge ratios within a range of values, and fragmenting the precursor ions to produce product ions. Subsequent to the step of selecting, the method may include directing the precursor ions or the product ions to a selected one of a first mass analyzer including a beam device and a second mass analyzer of a different type than the first mass analyzer.

The method may include controlling an ion path for the precursor ions or the product ions in which the step of directing further comprises changing the ion path from a first path through the first mass analyzer to a second path through the second mass analyzer. The method may further include changing the ion path in response to a triggering event, such as detecting an m/z ratio peak in the first mass analyzer.

### BRIEF DESCRIPTION OF THE DRAWINGS

FIG. 1A is a diagrammatic view of a hybrid mass spectrometer in accordance with an embodiment of the present invention;

FIG. 1B is a diagrammatic view of a hybrid mass spectrometer in accordance with another embodiment of the present invention;

FIG. 1C is a diagrammatic view of an alternative embodiment for a trap and detector portion of the mass spectrometer of FIGS. 1A and 1B;

FIG. 2 is a top plan view of a branched ion transfer device in a housing;

FIG. 3 is bottom plan view of the branched ion transfer device of FIG. 2 without the housing;

FIG. 4 is an end view of the branched ion transfer device taken in a direction of arrow IV of FIG. 3;

FIG. 5 is a sectional view of the branched ion transfer device taken along line V-V of FIG. 4;

FIG. 6 is a perspective view of a branched ion transfer device in accordance with an embodiment of the present invention;

FIG. 7 is a top plan view of an embodiment of the present invention that replaces electromechanical switches with electrical field switches;

FIG. 8 is a block diagram depicting a method in accordance with an embodiment of present invention;

FIG. 9 is a graph showing a relative abundance of an ion as analyzed in a triple quadrupole portion of a hybrid spectrometer of the present invention; and

FIG. 10 is a graph showing a relative abundance for a spectrum of ions as analyzed in the combination of the triple quadrupole and trap portions of a hybrid spectrometer in accordance with an aspect of the present invention.

### DETAILED DESCRIPTION OF EMBODIMENTS

The architecture of a mass analysis instrument in accordance with embodiments of the present invention enables users to obtain valuable additional details including structural information about samples and components of samples that are not readily available with conventional instruments. The architecture is that of a hybrid with a branched ion path in which a particular m/z or range of m/z can be isolated in a first branch and then ions having the same m/z as the isolated ions can be automatically diverted and analyzed in an ion trap in a second branch, for example. Thus, details only available in an ion trap along with details for specific m/z values or ranges of m/z that are only available with mass filters are now made available in the same instrument. The result is increased resolution, selectivity, and/or increased sensitivity for various analyses with a single instrument. As such, additional structural detail regarding a particular precursor or product ion may be obtained immediately by switching the ion beam path from the first path to the second path. In one embodiment the first path may extend through a triple quadrupole portion of the instrument, and the second path may extend into an ion trap portion of the instrument. As may be appreciated, a high sensitivity full scan spectrum can be obtained in the trap. At the same time a second group of ions can be analyzed in the triple stage quadrupole portion while the trap is being operated with ions previously collected. Thus, the instruments in accordance with the embodiments of the present invention also improve duty cycle relative to that which is available in performing two separate experiments in conventional instruments, for example.

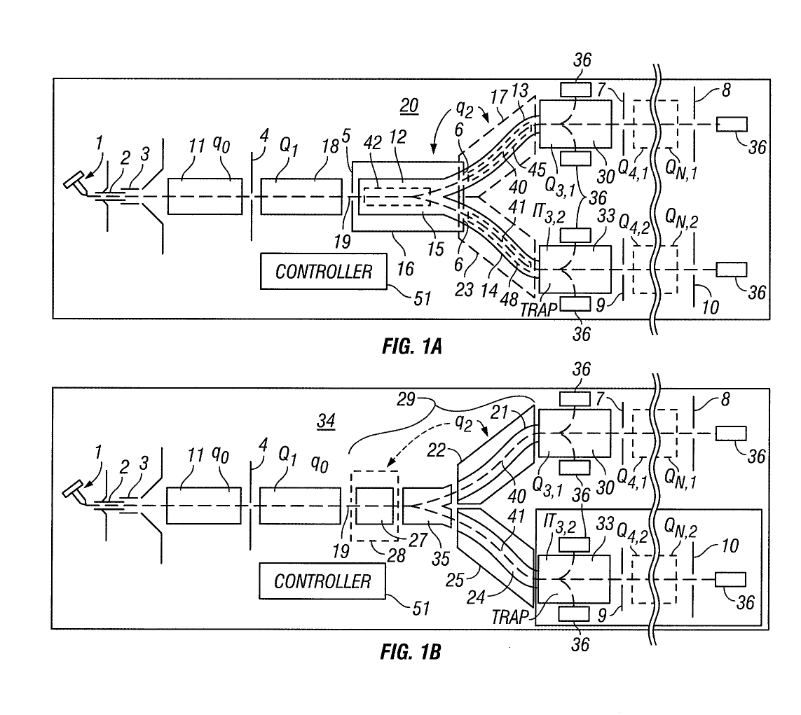

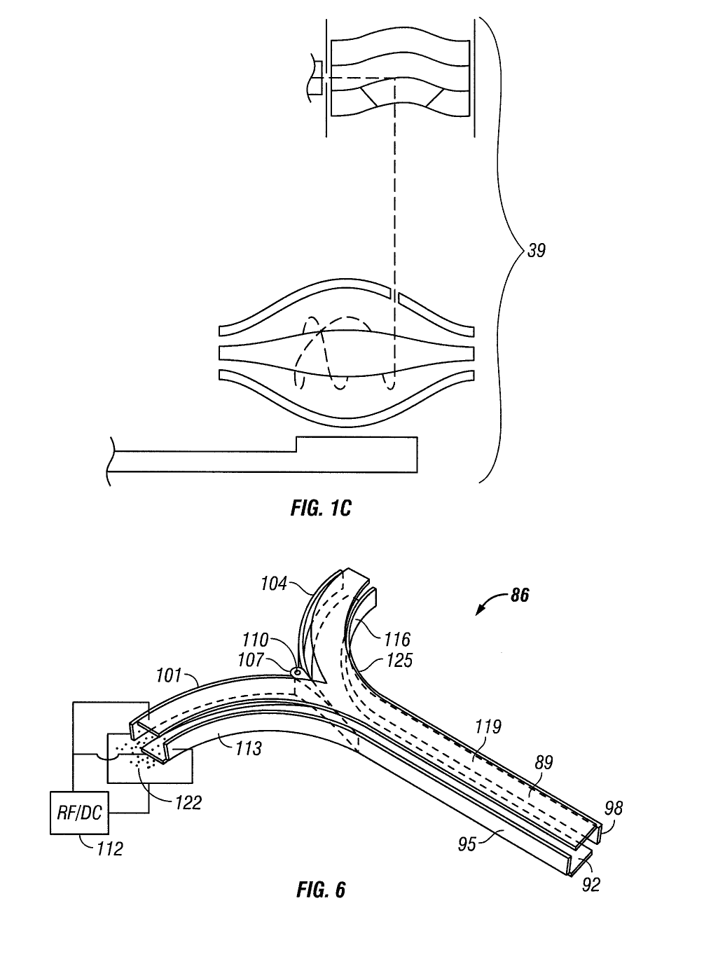

Accordingly, FIG. 1A shows a diagrammatic view of an example of a mass spectrometer 20, constructed in accordance with an embodiment of the invention. Mass spectrometer 20 includes an ion source, such as electrospray ionization source 1, configured to generate ions from a sample to be analyzed. The ions are directed through intermediate chambers of successively lower pressure and are thereafter delivered to a mass selection device 18, also labeled Q₁. Efficient transport of ions through the intermediate chambers and along a remainder of the ion paths 19, 40, and 41 may be achieved using various ion optical elements, including (without limitation) ion transfer tube 2, electrostatic lenses 3, 4, 5, 6, 7, 8, 9, and 10 and radio-frequency (RF) ion guides 11, 12, 13, and 14, also generally labeled q₀ and q₂ in FIGS. 1A and 1B. More ion guides of any type may be included without limitation.

It is to be understood that a first subscript in the description and accompanying figures represents the stage. A second subscript, when present, represents the branch among a plurality of branches. Thus, in the first branch the subscripts for stages three and four of the mass spectrometry would be 3,1 and 4,1, for example. The abbreviations for the various devices in the illustrated examples of instruments use conventional and otherwise easily correlated letters with subscripts to identify the stage and branch. For example, a mass filter has the designation “Q”, an ion guide or collision cell has the designation “q”, and an ion trap has the designation “IT”. Thus, an ion trap forming a fourth stage on a second branch will have the designation IT_{4,2}.

The mass selection device 18, which may take the form of a first quadrupole mass filter Q₁, is configured to select (either in a fixed or scanned mode of operation) ions having mass-to-charge ratios (m/z's) within a narrow range of values. Alternatively, the mass selection device may include a Wein filter, momentum analyzer, or some other selection device. The selected ions flow to an entrance end of a branched ion transfer device 15, which includes a trunk corresponding to ion guide 12 joined to first and second branches 40, 41 corresponding to respective ion guides 13 and 14. These ion guides 12, 13, and 14 are also generally labeled q₂ since they provide the second stage corresponding to a branched ion transfer device 15 from the mass filter Q₁. In the embodiment depicted in FIG. 1A, the interior of the branched ion transfer device 15 or a portion thereof may be enclosed by one or more chambers 16, 17, 23 that is pressurized with a collision (or reaction) gas. Thus, the branched ion transfer device 15 may incorporate one or more collision cells 42/45/48 for the fragmentation of the selected ions. The resultant product ions are then directed to a selected one of a mass analyzer 30 (also labeled Q_{3,1}) in the first branch, which may take the form of a quadrupole mass filter, and an ion trap mass analyzer 33 (also labeled IT_{3,2}) in the second branch in a manner more fully described below. A control and data system 51, which will typically include a combination of application-specific circuitry, general and special-purpose processors, and software and firmware instructions, communicates with the various components of the mass spectrometer 20 to effect the desired control and data acquisition functions.

A branched ion path 19 within mass spectrometer 20 is composed of the first and second ion paths 40 and 41 having common and divergent portions. The first ion path 40 extends from the source 1 through first quadrupole mass filter or mass filter 18, branched ion transfer device 15, the mass analyzer 30 in the first branch, and radially or axially to one or more ion detectors 36. If the mass analyzer 30 is a second quadrupole mass filter, then the detectors will be axially located. In any case, the ion detector(s) generate a signal representative of the abundance of ions transmitted through second quadrupole mass filter or mass analyzer 30 in the first ion path 40. Ions traveling along the first ion path 40 experience a first mass selection followed by fragmentation, and a second mass selection of product ions in a manner substantially identical to ions traveling through a conventional triple quad mass spectrometer. As is known in the art, the mass selection device 18 and the mass analyzer 30 may be operated as first and second quadrupole mass filters in prescribed combinations of scanned and fixed (parked) modes to acquire various types of mass spectra of the ions derived from the sample. These modes include, but are not limited to, modes for obtaining precursor ion spectra, product ion spectra, selected reaction monitoring (SRM) spectra, multiple reaction monitoring (MRM) spectra, and neutral loss spectra. Thus, by directing ions along first ion path 40, mass spectrometer 20 is capable of producing results substantially identical to those obtained by employing a conventional triple quad mass spectrometer.

The second ion path 41 extends from the ion source 1 through the first quadrupole mass filter or mass selection device 18, the branched ion transfer device 15, the ion trap 33 of the second ion path 41, and radially or axially into one or more ion detectors 36 (which generates a signal representative of the abundance of ions in the trap 33 and their m/z values). Ions traveling along second ion path 41 experience a first mass selection, followed by fragmentation, trapping, and detection of a spectrum of product and/or precursor ions. The first quadrupole mass filter or mass selection device 18 may be operated in prescribed combinations of scanned and fixed (parked) modes to acquire various types of mass spectra of the ions derived from the sample. The collision cell 42 and/or collision cell 48 may be operated to fragment the ions in any predetermined manner. Thus, the ions analyzed in the ion trap 33 may produce product ion spectra of the ions selected or scanned by the mass filter or mass selection device 18. Therefore, by directing ions along the second ion path 41, mass spectrometer 20 is capable of detecting more structural details and generating full spectra showing those details for a whole sample or a selected range of m/z values within the sample, as is only possible in an ion trap.

It is to be understood that Q₁ may be operated in RF only mode and there may be no collision gas in a subsequent stage. In this way the ions may be introduced without having been filtered or fragmented into the ion trap, and the trap may be operated as a regular trap. When operated in this way, a collision gas in the trap may be used to cause collision induced dissociation at resonant frequencies for ions of particular m/z value(s) for MSⁿ. Alternatively, Q₁ may be operated as a filter to mass select a particular m/z or range of m/z with no collision gas in a subsequent stage. Then the ions may be introduced into the trap for regular operation of the trap including collision induced dissociation for MSⁿ. Implementing mass selection in Q₁ may provide the benefits of reducing space charge effects and increasing mass resolution in the subsequent ion trap, or to reduce the time for ion selection and thereby increase duty cycle. Further alternatively, Q₁ may be operated as a filter, a subsequent stage may include a collision cell q₂, and the trap may be operated for MSⁿ where n is equal to 3 or more.

To enable the selective operation of the mass spectrometer 20 as a triple quad or an ion trap, the branched ion transfer device 15 may have a downstream end that includes two or more outlets connected to respective downstream portions of the branched ion path 19. Each of the trunk and branches correspond to respective ion guides 12, 13, and 14 and may be integral with the rest of the branched ion transfer device 15 (as shown in the embodiment of FIG. 1A), or may have one or more of a separate ion guide 27, valve piece 35, and ion guides 21, 24 forming the trunk and branches of the branched ion transfer device 29. In one embodiment, the ion guides 21, 24 diverge from the ion guide 27 and valve piece 35 (as shown in the embodiment of FIG. 1B). It is to be understood that all or part of the trunk and branches of the branched ion path 19 may be integrally formed. Alternatively, the ion guide 27 of the trunk, valve piece 35, and the ion guides 21, 24 of the branches may be formed by separate elements, which may be joined together to form a branched ion transfer device 29, as shown in FIG. 1B.

The embodiment of FIG. 1B shows the ion valve piece 35 as a separate piece disposed between the ion guide 27 in the trunk upstream and the ion guides 21, 24 of the first and second branches downstream of the valve piece 35. Functionally, this embodiment with separate pieces is similar to the embodiment of FIG. 1A in which the trunk, valve, and branches are unitary or integral with each other. It is to be understood that ion transfer devices 15/29 may have one or more integral portions or separate pieces added onto a remainder of the ion transfer device 15/29 without limitation. Also, it is to be understood that the collision cells may be positioned upstream, downstream, or both upstream and downstream of the valve or the valve piece in both of the embodiments of FIGS. 1A and 1B without departing from the spirit and scope of the invention. The embodiment of FIG. 1B is considered to be otherwise similar to the embodiment of FIG. 1A and like elements are labeled with the same numerals.

In FIG. 1A the dashed lines of elements 17 and 23 indicate an alternative position for chambers forming collision cells in the branches of the branched ion transfer device 15. In FIG. 1B, elements shown by solid lines 22 and 25 indicate chambers forming collision cells in the branches of ion guides 21 and 24 respectively. Alternatively or additionally, a collision cell may be formed by a chamber 28 surrounding the ion guide 27 upstream of the valve piece 35. It is to be understood that the locations of the chambers forming collision cells may be mixed and matched in any combination among the embodiments of the present invention without limitation.

FIGS. 1A and 1B show the first and second mass analyzers downstream of the first and second ion paths 40, 41 of the branched ion transfer device 15 as Q_{3,1} and IT_{3,2} (labeled TRAP). Notwithstanding the chosen abbreviations, it is to be understood that Q_{3,1} may be a quadrupole or other multipole, while IT_{3,2} may be a two dimensional trap, a three dimensional trap, or an electrostatic trap, for example. FIG. 1C is a diagrammatic view of an electrostatic trap 39, such as an Orbitrap™ for example and a corresponding detector that may replace the mass analyzer 33 and detector 36 of FIGS. 1A and 1B. When the mass analyzer 33 (being a trap IT_{3,2}) in the second path 41 is replaced by the electrostatic trap, additional stages of MS are not available downstream from the electrostatic trap. Otherwise, additional ion transfer devices connecting to additional mass filters, analyzers, detectors, or other elements may be added downstream or upstream without limitation. The number of possible additional stages may be expressed as Q_{N}, of which Q_{N,1} and Q_{N,2} shown in FIGS. 1A and 1B are examples. Furthermore, additional branches or additional branched ion guides may be added without limitation.

Embodiments of the invention are not limited to an architecture having a beam device in one branch and a non-beam device in another branch. Rather, embodiments may include a system having two beam devices in respective branches. In one case, the mass analyzer 33 may have a magnetic sector device instead of the trap IT_{3,2}, and additional stages may or may not be added downstream. Alternatively, the system may have two non-beam devices such as a quadrupole ion trap, and a TOF (or orbitrap), for example. Any combination of beam and non-beam devices may be incorporated in any number of branches without limitation.

During use of the illustrated embodiments, when additional structural information yielding identification or verification of ions is a goal, a path of the ions can be switched to enter the second mass selection device 33 of ion path 41 in FIGS. 1A and 1B or the electrostatic trap 39 of FIG. 1C for further analysis. For example, a complete spectrum may be detected when the second mass selection device 33 in the second ion path 41 is a two dimensional trap, three dimensional trap, an electrostatic trap, or a time-of-flight mass spectrometer. In order to switch the path of the ions from one of the branches corresponding to ion guides 13/21 to the other branch corresponding to ion guides 14/24, a controller 51 may be operatively connected to the mass analyzer 30 in the first ion path 40 and the branched ion transfer device 15/29. The controller 51 can activate an ion guide switch within the branched ion transfer device 15/29 to redirect the ions at a predetermined time during analysis, as will be described below.

The controller 51 is also configured to select a mode of operation. The controller 51 is operably connected to the first mass selection device 18 and the mass analyzer 30 downstream of the branched ion transfer device 15/29 in the first ion path 40. The controller 51 initiates an analysis mode of operation from among several modes. For example, the controller can select a product ion scan mode and cause the mass selection device 18 to operate as a mass filter to select ions of a predetermined m/z. In this mode, the controller 51 further causes the mass analyzer 30 (also labeled Q_{3,1}) in the first ion path 40 to scan product ions received from the collision cell 42/45 in the product ion scan mode. The controller 51 can alternatively or additionally select one or more other modes including, but not limited to, a precursor ion scan mode, a neutral loss scan mode, a selected reaction monitoring (SRM) mode, and a multiple reaction monitoring (MRM) mode. For each of these modes, the controller initiates the mode, causes the mass selection device 18 to scan ions through a predetermined range of m/z values or to select ions by filtering all ions but those having a predetermined range of m/z. Then the controller causes the mass analyzer 30 (also labeled Q_{3,1}) to operate as a mass filter or scanning device to select ions having a predetermined m/z ratio received from the collision cell 42/45 or to scan them. Additional information about the ions can be obtained by switching the path of the ions such that they enter the mass analyzer 33 (also labeled IT_{3,2} or Trap) of the second ion path 41 for additional or alternate analysis.

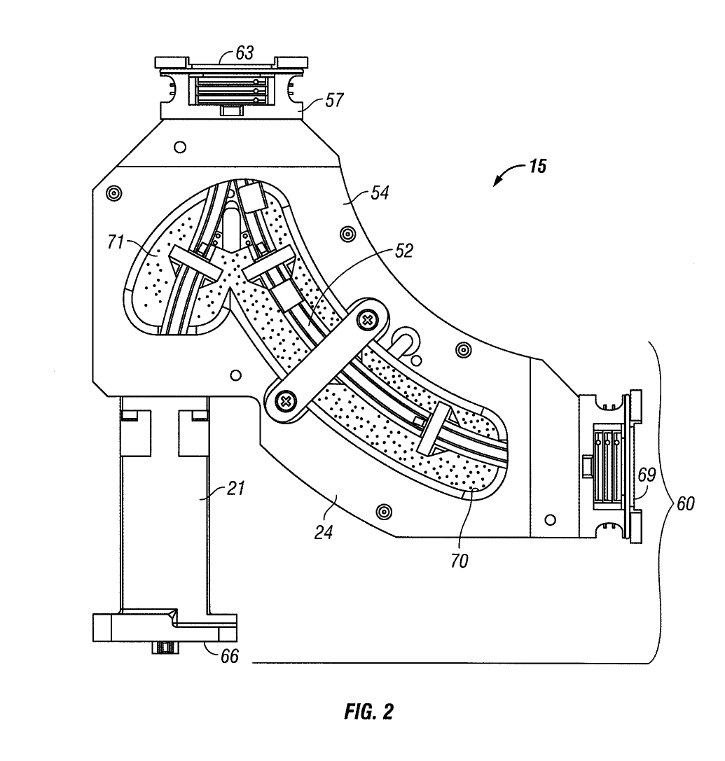

FIG. 2 is a top plan view of the branched ion transfer device 15 including a branched quadrupole ion guide 52 in a housing 54. The branched ion transfer device 15 has a first end 57, and a second end 60 that may include the two branches or ion guides 13, 14. The first end 57 may be an upstream end and the second end 60 may be a downstream end. As such, the branched ion transfer device 15 has an inlet 63 and two outlets 66, 69. Alternatively, the number of outlets could be three or more. In the embodiment shown in FIG. 2, the housing 54 forms collision cells 45, 48 (shown schematically in FIG. 1A) integral with the branches or ion guides 13, 14 since opening 70 is configured to be sealed against an interior wall within the instrument 20 forming an isolated chamber for a collision gas 71. In an alternative or additional embodiment, the branched ion transfer device may be reversed so that the plural branches are upstream and the single branch is downstream such as for introducing ions from two or more ion sources into an instrument, or potentially sending two or more ion streams to a single detector, for example. In one aspect, ions from a second sample may be analyzed in the first analyzer while ions from a first sample are being analyzed in the second analyzer.

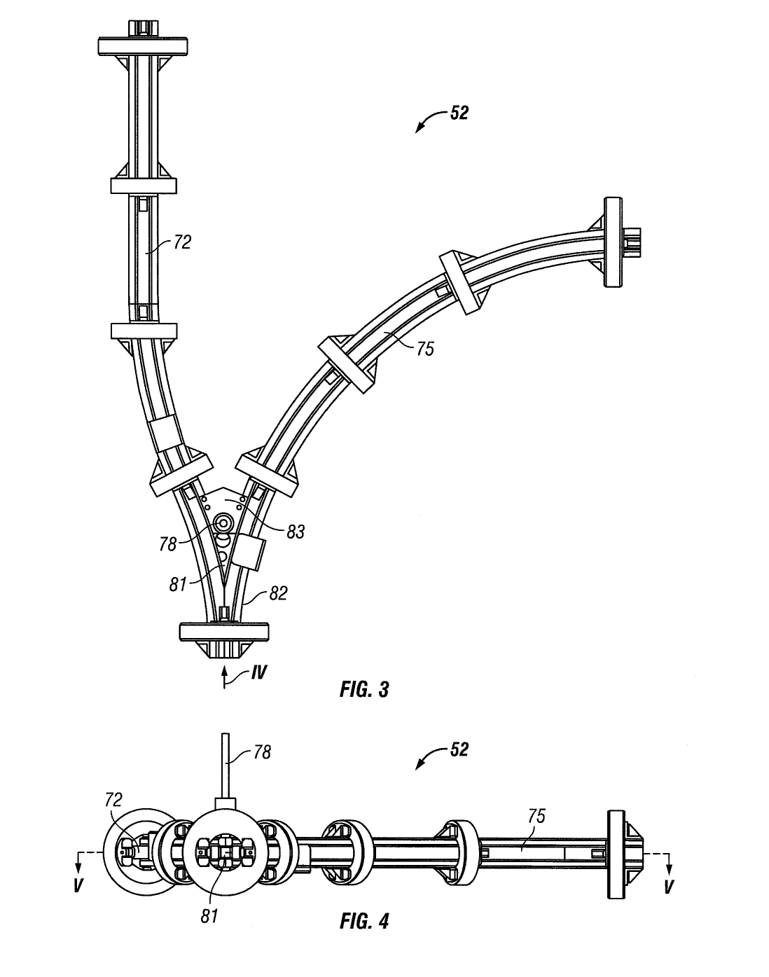

FIG. 3 is a bottom plan view of the branched quadrupole ion guide 52 without the housing 54. As shown, the branched quadrupole ion guide 52 may include a plurality of segments having a bent configuration for creating branched or diverging portions of the first and second ion paths 40, 41 of the branched ion path 19. Alternatively expressed, the branches help to define first and second ion paths in which upstream portions of the paths are common to each other and downstream portions of the paths separate or diverge from each other. The meaning of separate includes the case where one or more of the paths may be straight or substantially straight, but physically separate from another of the paths. It is to be understood that the segments of a first quadrupole branch 72 may have four or more rods with opposite RF voltages being applied to transverse pairs of rods to radially contain ions in the guide. A length of the first ion path through the first quadrupole branch 72 may be equal to a length of the second ion path through the second quadrupole branch 75. Thus, the two quadrupole branches 72, 75 are symmetrical. Different DC voltages may be applied to segments to cause a desired axial movement along the branched ion path 19. FIG. 3 and the end view shown in FIG. 4 taken in a direction of arrow IV in FIG. 3 show a pivot 78 supporting a flipper 81 of an electromechanical ion path switch 83 housed generally at a junction 82 between the first and second quadrupole branches 72, 75.

When energized with an appropriate RF voltage and placed in a position that forms a continuous space within the branched quadrupole ion guide 52, the flipper 81 helps to form an ion gate or an ion beam gate that inhibits passage along one path and facilitates passage of ions along another path. The ion path switch 83 is actually an ion beam switch that includes an ion gate with a junction and a valve at the junction. The flipper 81 is analogous to a movable shutter in a mechanical valve. However, as will be described below, the valve or gate need not be mechanical or electromechanical.

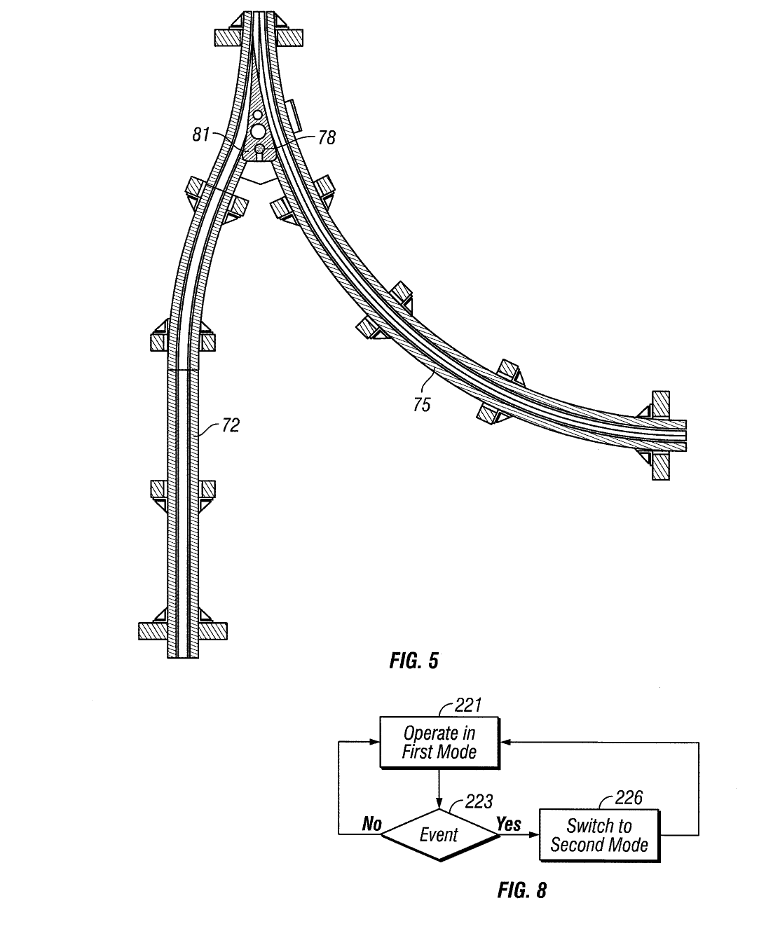

FIG. 5 is a sectional view of the branched quadrupole ion guide 52 taken along line V-V of FIG. 4 showing the flipper 81 supported on the pivot 78 such that the flipper 81 is rotatable between at least a first position and a second position. The flipper 81 is shown in the second position in FIG. 5. The flipper 81 positionally replaces parts of each of respective sections of rods of the respective quadrupoles that form the junction 82 between the branches 72, 75. A voltage is applied to the flipper 81. The voltage applied to the flipper 81 corresponds to the voltage that would have been applied to the part of the respective section of the rods which flipper 81 physically replaces. The voltage may be selected to be the same as a voltage that would be applied to the part of the rods during regular ion guiding operation. Thus, the flipper 81 and the rest of the rods smoothly guide ions along the path in one or the other of the branches 72, 75. In the second position, the flipper 81 will direct ions into the second branch 75 toward a second mass analyzer, for example. The flipper 81 is moved to the second position in which the second quadrupole branch 75 is open from a first position in which the first quadrupole branch 72 was open. Movement of the flipper 81 from the first to the second position may be in response to detection of a peak at a predetermined m/z ratio in a first mass analyzer in the first ion path, for example. The flipper 81 may be moved by a piezo device or another actuator.

FIG. 6 shows an alternative embodiment of a branched multipole ion guide 86 formed of plate electrodes that could be substituted for the branched quadrupole ion guide 52 of FIGS. 1A-5. It is to be understood that top and bottom electrodes 89, 92 and side electrodes 95, 98, 101, and 104 may be segmented. Additionally or alternatively, these electrodes may be provided as two or more separate electrode sets similar to the embodiments of FIG. 1B. Otherwise, the branched guide 86 can function substantially similar to the branched ion guide 52 of FIGS. 1A-5. A flipper 107 may be supported on a pivot 110 similar to the embodiment of FIGS. 1A-5. RF and/or DC may be applied by a power supply 112. Collision cells may be set up in one or more of branches 113, 116, and a trunk 119 by enclosing a gas 122, as shown and described with regard to the embodiment of FIGS. 1-5. An appropriate voltage may be applied to the flipper 107, and the flipper 107 may be moved through a junction 125 into a first position or a second position to guide the ions along a desired branch or portion of first and second ion paths 40, 41 of the branched ion path 19, as described with reference to FIGS. 1A and 1B above.

The ion gates need not include specific structure having first and second branch sections. It is also to be understood that electromechanical ion gates are not limited to the specifics of a “flipper” like that disclosed above and in U.S. patent application Ser. No. 11/542,076, entitled SWITCHABLE BRANCHED ION GUIDE, filed Oct. 2, 2006, and Provisional Patent Application Ser. No. 60/799,813, entitled SWITCHABLE BRANCHED ION GUIDE, filed May 5, 2006, both by Alan E. Schoen, both of which are incorporated herein by reference in their entirety. While the flippers 81/107 together with internal structural features of the branched ion guides at respective junctions help to form ion gates or ion beam gates with valves, many other switching mechanisms and movements may be incorporated without limitation. For example, devices that are moveable or rotatable in other ways or about other axes such as the movable guide of U.S. Pat. No. 5,825,026 to Baykut, incorporated herein by reference, may be substituted for the switches or ion gates disclosed herein without departing from the spirit and scope of the present invention.

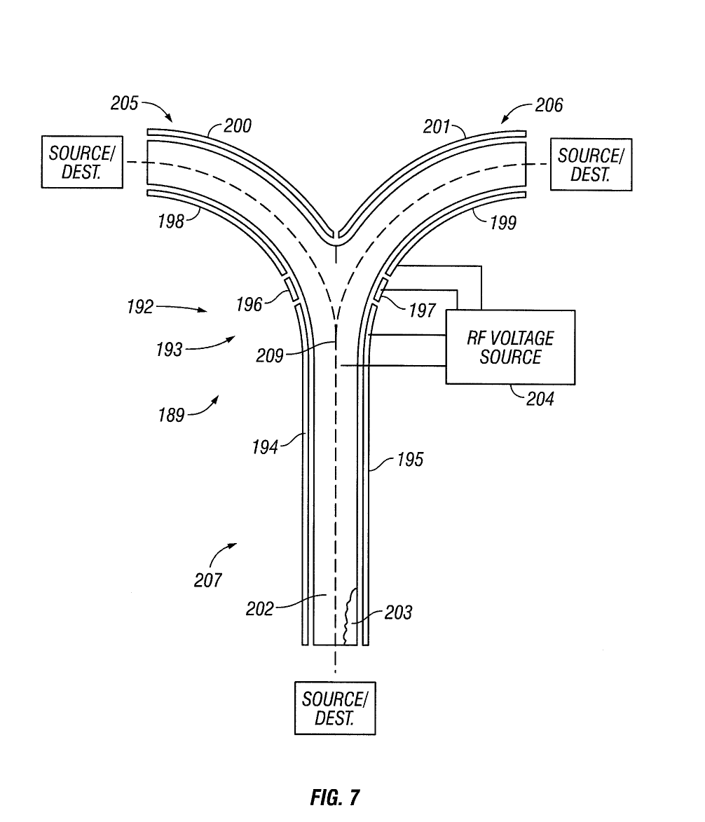

FIG. 7 shows a top plan view of a branched RF ion guide 189 having an RF ion path switch 192 including side electrodes 194, 195, 196, 197, 198, 199, 200, and 201, and top and bottom electrodes 202, 203 connected to an RF voltage source 204 that provides voltages through operation of a controller to set up electrical fields that limit ions entering or exiting one of branches or branch 205, 206 from a trunk 207 while allowing passage of the ions to or from the other of branches 205, 206 through the trunk 207. The branches 205, 206 and trunk 207 may be termed branch sections and trunk sections. Other configurations of segmentation of the electrodes may be implemented. For example, electrodes described in US. patent application Ser. No. 11/373,354, entitled BRANCHED RADIO FREQUENCY MULTIPOLE, by Viatcheslav V. Kovtoun, filed Mar. 9, 2006, incorporated herein by reference, may be implemented without limitation. RF gates provide ion gates or ion beam gates with valves analogous to the electromechanical ion gates and valves described herein. One or more of the trunk, branch, and valve sections may be provided as separate pieces connected together to form the branched ion transfer device and the branched ion path, as may be applied with any of the embodiments of the present invention.

With further reference to FIG. 7, the RF ion path switch 192 is an ion beam switch that includes a switchable RF ion path switch with a gate at a junction 193 for selectively connecting the trunk 207 with at least one of the first branch 205 and the second branch 206. Each of the trunk 207, the first branch 205, and the second branch 206 will include at least two electrode pairs to which are applied opposite phases of an RF voltage from the voltage source 204. Thus, the electrodes and applied voltage form an ion valve at the junction 193. The valve is switchable between a first state that allows ion travel between interior volumes of the trunk 207 and first branch 205 and impedes ion travel between interior volumes of the trunk 207 and second branch 206. The valve may be switched to a second state that allows ion travel between interior volumes of the trunk 207 and second branch 206 and impedes ion travel between interior volumes of the trunk 207 and first branch 205.

In the embodiment of FIG. 7, the RF voltages and fields may be configured to selectively allow ions to move along a branched path 209 from the trunk 207 into the branches 205, 206. Alternatively, the branched path 209 and voltages could provide movement in a reverse direction from one or both of the branches 205, 206 into the trunk 207. DC potentials and/or additional segmentation may be implemented to cause movement of ions along the branched ion path 209.

In an example of a method that may be implemented in accordance with an embodiment of the present invention, a mode of operation for a mass spectrometer may be selected under software or firmware control. The modes of operation may include, but are not limited to, product ion scan mode, precursor scan mode, neutral loss scan mode, selected reaction monitoring (SRM) mode, and multiple reaction monitoring (MRM). In another preliminary step of the method, an m/z ratio or range of ratios of interest may be selected in a mass filter. Ions may be generated from a sample in any manner including, but not limited to, electrospray ionization. One or more steps in the method may include fragmentation of the ions. Another step that may be implemented before or after the step of fragmentation is a step of determining an ion path or path branch for the precursor and/or product ions.

In accordance with the method, a mass spectrometer may be initially operated under software or firmware control to guide ions of an ion beam along a first portion of a branched path through a first mass analyzer, which may include a quadrupole or other multipole device. This may be considered a first mode of operation as indicated by block 221 in FIG. 8. When an event 223 occurs such as the detection of a peak or an m/z value of interest, the path may be switched so that ions of the ion beam are thereafter sent to a second mass analyzer, as indicated at the block 226. Alternatively, the event 223 may simply be a point in time. For example, the event may be an external event such as an event in a chromatograph from an alternate detector unrelated to the mass spectrometer. This switching may be effectuated automatically under software or firmware control, and/or may be initiated by one or more external stimuli. Operation of the mass spectrometer in which ions are being sent to the second analyzer may be considered to be operation in a second mode. More detailed or complimentary information may be obtained by analysis in the second mass analyzer. For example, the second mass analyzer may comprise an ion trap. Additional modes may include switching the ion beam back and forth between the first and second analyzers in a repeated manner, or starting operation in the first mode anew based on an m/z or range of m/z values discovered while operating in the second mode. Whether analyzing in the first or second mass analyzer, data is obtained and processed under software control or firmware control. Further fragmentation and analysis in the second mass analyzer, for example, may be implemented. Alternatively or additionally, the method may be repeated without limitation on the same or another sample. Similarly, targeting a different m/z ratio from an original sample in the first mass analyzer may be implemented while ions of an initial m/z ratio in the original sample are being analyzed in the second analyzer. This capability improves the duty cycle for the instruments of the present invention.

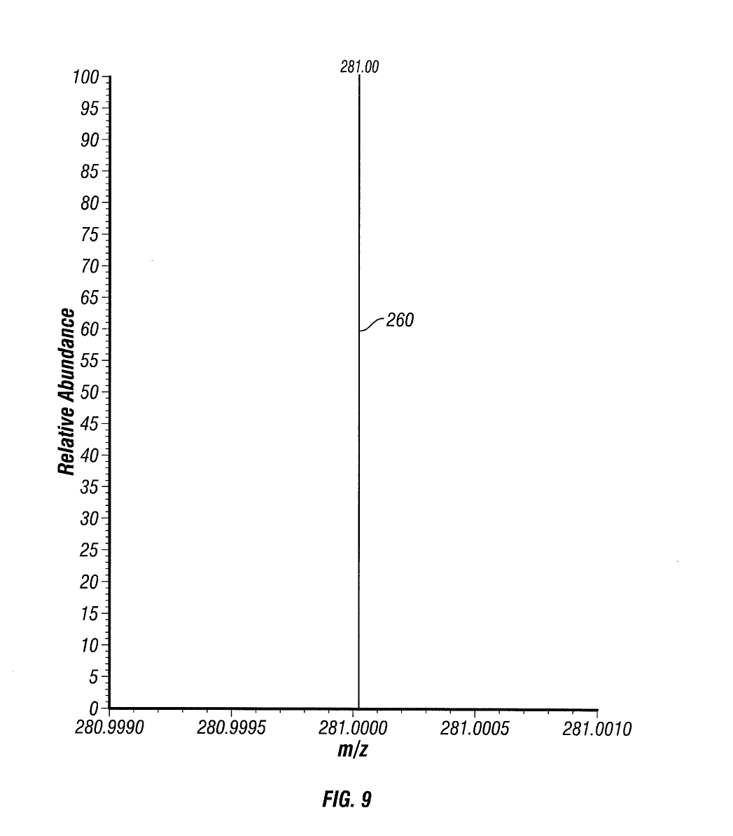

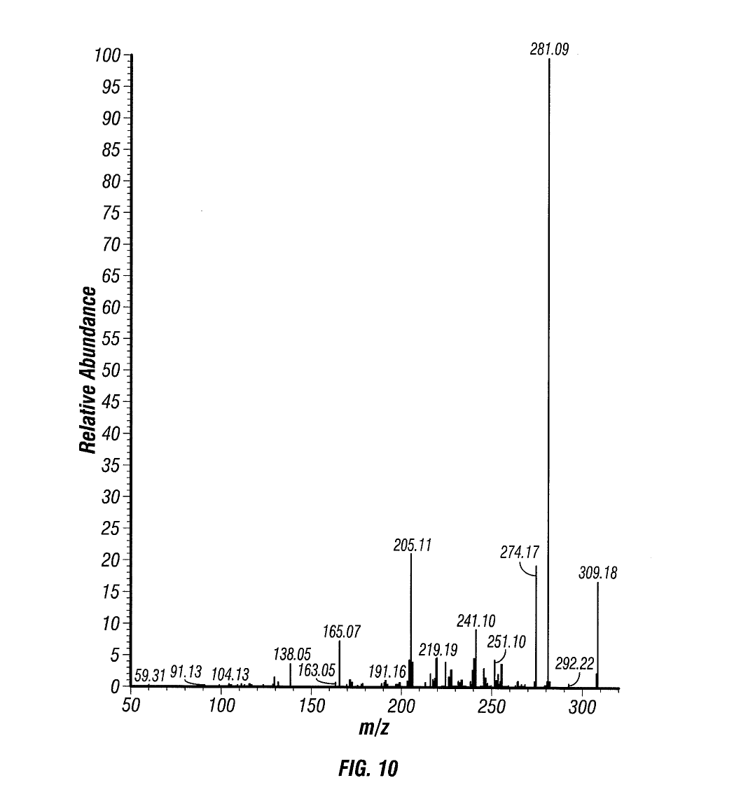

FIG. 9 is a graph showing an example of results from a scan in the triple stage quadrupole portion of a mass spectrometer in accordance with an embodiment of the present invention. Detection of an ion having an m/z ratio near 281 is indicated by the single peak 260. The relative abundance has been normalized to a value of 100. FIG. 10 is a graph of the results of analysis in an ion trap that is accomplished when an ion path switch is activated to take advantage of the architecture of embodiments of the present invention. Activation of the ion path switch may be effectuated when a predetermined triggering event occurs, such as detection of a peak corresponding to an m/z value of interest in a first mass analyzer in the triple stage quadrupole portion of the instrument, for example. The result of activating the ion path switch is that ions in the ion beam will thereafter be guided into and analyzed in the ion trap portion of the instrument. FIG. 10 shows how an entire spectrum is generated for the ions in the trap. As may be appreciated, the data represented by the graph of FIG. 10 yields much more information about the ion of interest than the data from analysis limited to the first mass analyzer. The abundance of peaks in addition to that of m/z 281 can supply information about key fragments or precursor ions. Thus, validation and identification of ions are facilitated. Furthermore, structural details for constituents in a sample can be determined more readily by analysis in the ion trap portion of the hybrid instruments in accordance with embodiments of the present invention.

It has been found that while additional information is made available by these hybrids, higher resolution and greater sensitivity to match or exceed that of respective portions of the instrument can result. For example, sensitivity to match that of the triple stage quadrupole is maintained when the method is carried out in the selected reaction monitoring (SRM) mode while enabling full spectrum information from the trap in a second portion of the instrument on the range of m/z selected in the mass analyzer of the first portion of the instrument. Furthermore, it is contemplated that for ions that fragment extensively, such as steroids and proteins, the collection of full scan MS/MS in these hybrids would likely provide additional ion current. Thus, monitoring multiple reaction pathways for these compounds would provide improved sensitivity over the triple stage quadrupole portion of the instrument, for example.

In accordance with embodiments of the present invention, ions can be fragmented prior to entering the ion trap. Because ions are fragmented prior to entering the ion trap, the time that would have been spent fragmenting them in the trap can be spent analyzing the ions. Therefore, duty cycle is improved. Furthermore, by fragmenting the ions prior to their entry into the ion trap, a problem of low mass cutoff is avoided. That is, when the ions are fragmented in the ion trap, the required frequency for fragmenting also eliminates ions at or below a particular threshold mass. Low mass cutoff is not a problem when the fragmentation is implemented prior to introduction of the ions into the trap.

To at least in part reiterate an advantage of embodiments of the present invention, mass spectrometers and associated methods in accordance with the embodiments of the present invention enable increased duty cycle. For example, after the ion path has been switched so that a first group of ions is being analyzed in the ion trap of the second mass analyzer, a second group of ions may be analyzed in the first mass analyzer while the first group of ions is being analyzed in the second analyzer. Similar advantages may be perpetuated in third, forth, and any number of additional stages of collision cells, beam or path switches, and mass analyzers. These stages may be added and interconnected in any combination without departing from the spirit and scope of the invention.

The architecture of the instrument in accordance with embodiments of the invention has been described in terms of first and second mass analyzers in first and second branches or ion paths, respectively. These mass analyzers have been shown and described as including a quadrupole mass filter or other beam device in the first branch or ion path and an ion trap or non-beam device in the second branch or ion path. It is to be understood, however, that any combination of mass analyzers may be placed in the first and second branches or ion paths. For example, the first mass analyzer in the first branch may be an ion trap or other non-beam device while the second analyzer in the second branch may be a time-of-flight (TOF) analyzer. Alternatively, the first and second mass analyzers in the first and second branches may be respective first and second ion trap mass analyzers or other devices. Still further, the branched path configuration with an ion beam or path switch at the junction of the branches may be implemented with a linear trap upstream of the switch and a variety of analyzers in the respective branches downstream of the switch. The downstream analyzers may include an electrostatic trap and a TOF, for example.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims. For example, it is to be understood that features of any of the embodiments disclosed or incorporated herein may be applied to any other of the embodiments disclosed or incorporated herein without limitation. All such combinations are considered to be within the spirit and scope of the invention.

What is claimed is:

1. A mass spectrometer comprising:
a mass selection device in an ion path;
at least one collision cell downstream of the mass selection device in the ion path;
a beam switch downstream of the mass selection device, the beam switch having at least a first outlet and a second outlet; and
at least a first mass analyzer including a beam device and a second mass analyzer including a non-beam device, the first and second mass analyzers being respectively coupled to the first and second outlets, the first and second mass analyzers located downstream of the mass selection device, the at least one collision cell, and the at least one beam switch;
wherein the beam switch directs an ion beam to a selected one of the first and second mass analyzers.

2. The mass spectrometer of claim 1, wherein the beam device is a quadrupole mass filter and the non-beam device is an ion trap.

3. The mass spectrometer of claim 2, wherein the ion trap is a two-dimensional quadrupole ion trap.

4. The mass spectrometer of claim 1, wherein the at least one collision cell consists of a single collision cell located upstream in the ion path relative to the beam switch.

5. The mass spectrometer of claim 1, wherein the at least one collision cell includes first and second collision cells located downstream in the ion path relative to the beam switch, the first and second collision cells being located upstream of the first and second mass analyzers, respectively.

6. The mass spectrometer of claim 1, wherein the ion path includes first and second ion paths within the ion path, wherein:
the beam switch comprises an ion gate having a junction and a valve at the junction; and
the valve is switchable between a first switching configuration corresponding to guiding ions along the first ion path toward the first outlet and a second switching configuration corresponding to guiding ions along the second ion path toward the second outlet.

7. The mass spectrometer of claim 1, wherein the beam switch comprises:
a trunk section, a first branch section, a second branch section, and a junction connecting the trunk section with the first and second branch sections; and
an electromechanical ion gate having a valve member positioned at the junction, the valve member being movable between a first position that allows ion travel between interior volumes of the trunk and first branch sections and impedes ion travel between interior volumes of the trunk and second branch sections, and a second position that allows ion travel between interior volumes of the trunk and second branch sections and impedes ion travel between interior volumes of the trunk and first branch sections.

8. The mass spectrometer of claim 1, wherein the beam switch comprises:
a trunk section, a first branch section, a second branch section, and a junction connecting the trunk section with the first and second branch sections, each of the trunk section and the first and second branch sections including at least two electrode pairs to which opposite phases of a radio frequency voltage are applied, the electrodes forming an ion valve at the junction; and
a switchable RF ion gate including an ion valve at the junction, the valve being switchable between a first state that allows ion travel between interior volumes of the trunk and first branch sections and impedes ion travel between interior volumes of the trunk and second branch sections, and a second state that allows ion travel between interior volumes of the trunk and second branch sections and impedes ion travel between interior volumes of the trunk and first branch sections.

9. The mass spectrometer of claim 1, further comprising at least one additional mass analyzer downstream of one of the first and second mass analyzers.

10. The mass spectrometer of claim 1, wherein the beam switch includes a plurality of electrodes arranged to define an internal volume, and at least a portion of the internal volume is pressurized with a collision gas to define the at least one collision cell.

11. The mass spectrometer of claim 1, further comprising a controller operably connected to the mass selection device and the first mass analyzer in which the controller initiates one of a product ion scan mode and a selected reaction monitoring (SRM) mode and causes the mass selection device to operate as a mass filter to select ions of a first predetermined m/z ratio, and wherein the controller further causes the first mass analyzer to either scan product ions received from the collision cell in the product ion scan mode or operate as a mass filter to select product ions of a second predetermined m/z ratio received from the collision cell in the selected reaction monitoring (SRM) mode.

12. The mass spectrometer of claim 1, further comprising a controller operably connected to the mass selection device and the first mass analyzer in which the controller initiates at least one of a precursor ion scan mode and a neutral loss scan mode and causes the mass selection device to scan ions through a predetermined range of m/z values, and wherein the controller further causes the first mass analyzer to either operate as a mass filter to select product ions having a predetermined m/z ratio received from the collision cell in the precursor ion scan mode or scan product ions received from the collision cell through a second predetermined range of m/z values in the neutral loss scan mode.

13. A method of analyzing samples by tandem mass spectrometry, comprising:
generating ions from the sample;
selecting precursor ions having mass-to-charge ratios within a range of values;
fragmenting the precursor ions to produce product ions;
subsequent to the step of selecting, directing the precursor ions or the product ions to a selected one of a first mass analyzer including a beam device and a second mass analyzer of a different type than the first mass analyzer.

14. The method of claim 13, wherein the beam device comprises a quadrupole mass filter and the step of directing comprises directing the precursor or the product ions to a selected one of the quadrupole mass filter and the second mass analyzer.

15. The method of claim 13, wherein the step of directing comprises directing the precursor ions or the product ions to the first mass analyzer or to the second mass analyzer, wherein the second mass analyzer is an ion trap.

16. The method of claim 13, wherein the step of selecting precursor ions includes selectively transmitting ions through a quadrupole mass filter.

17. The method of claim 13, further comprising controlling a mode of operation of the first mass analyzer by placing the first mass analyzer in a product ion scan mode.

18. The method of claim 13, further comprising controlling a mode of operation of the first mass analyzer by placing the first mass analyzer in a precursor ion scan mode.

19. The method of claim 13, further comprising controlling a mode of operation of the first mass analyzer by placing the first mass analyzer in a neutral loss scan mode.

20. The method of claim 13, further comprising controlling a mode of operation of the first mass analyzer by placing the first mass analyzer in a selected reaction monitoring mode.

21. The method of claim 13, further comprising controlling an ion path for the precursor ions or the product ions, wherein the step of directing further comprises changing the ion path from a first path through the first mass analyzer to a second path through the second mass analyzer.

22. The method of claim 21, wherein the step of changing comprises changing the ion path in response to a triggering event.

23. The method of claim 22, wherein the step of changing the ion path in response to the triggering event comprises detecting an m/z ratio peak in the first mass analyzer and changing the ion path in response to the step of detecting.

24. The method of claim 21, wherein the second mass analyzer is an ion trap, the steps of directing and controlling further comprise:
analyzing first ions in the second mass analyzer; and
increasing duty cycle by analyzing second ions in the first mass analyzer while the first ions are being analyzed in the second mass analyzer.

25. A mass spectrometer comprising:
a mass selection device in an upstream portion of a branched ion path;
at least one collision cell in the branched ion path downstream of the mass selection device;
at least one ion path switch in the branched ion path downstream of the mass selection device, the ion path switch configured to alternatively guide ions toward one of first and second branches of the branched ion path; and
at least a first mass analyzer including a beam device and a second mass analyzer including a non-beam device, the first and second mass analyzers being respectively located in the first and second branches of the branched ion path downstream of the mass selection device, the at least one collision cell, and the at least one ion path switch;
wherein the ion path switch is configured to selectively direct ions along the respective branches of the branched ion path to one of the first and second mass analyzers.
